(19) United States
(12) Patent Application Publication
(10) Pub. No.: US 2023/0406028 A1
(43) Pub. Date: Dec. 21, 2023

(54) Greeting Card Keepsake Binder Insert

(71) Applicant: Evelyn Ravenell Brown, Stafford, TX (US)

(72) Inventor: Evelyn Ravenell Brown, Stafford, TX (US)

(21) Appl. No.: 17/836,362

(22) Filed: Jun. 9, 2022

(51) Int. Cl. B42F 5/00

(52) U.S. Cl. CPC B42F 5/00

(57) ABSTRACT

Extensive research and the corresponding USPTO Form 892 indicated some close artwork and some other things there were somewhat functional, however no items were found to be as significant as the Greeting Card Keepsake Binder Insert invention by ERB with the custom, unique of the slit opening to hold a greeting card in a three-ring binder.

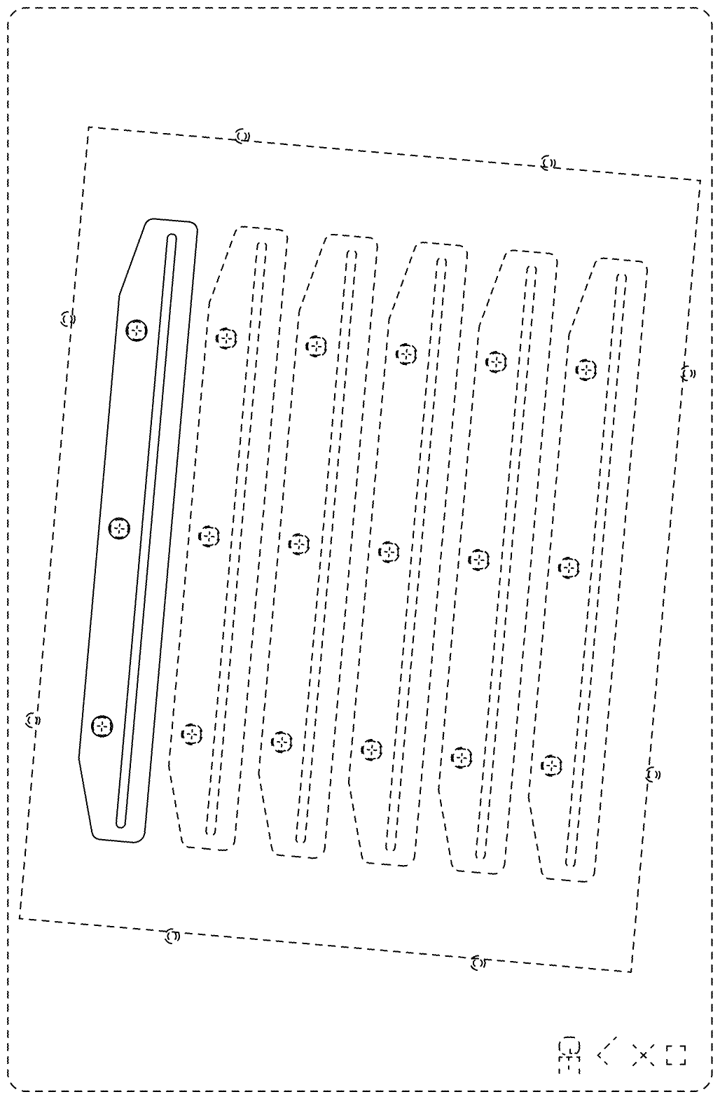

The title of this utility invention by Evelyn Ravenell Brown (ERB), resident of Stafford TX, proposed as a nonprovisional utility patent, is the Greeting Card Keepsake Binder Insert as a special utility binder insert, that can be used to maintain standard greeting cards in a three-ring binder for current enjoyment and future perusal memories.

### CROSS-REFERENCE TO RELATED APPLICATIONS

Claim priority benefit of a previously-filed co-pending reference as a continuation child application to parent application # 29/698,716. As such, no new information that was not already included in the parent application # 29/698,716 is being added at this time, as this proposed utility application for the greeting card keepsake binder insert is for use in a binder. The advantage of the Greeting Card Keepsake Binder Inset is that it provides a means for users to compile and review numerous traditional paper greeting cards over time for preservation and memory recall.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

After extensive research, ERB was unable to find a specialty binder insert to securely hold greeting cards in an organized manner such as loose-leaf paper collections in binders. In turn, using multiple and varied resources, ERB arrived at a presentable solution by inventing the custom, unique Greeting Card Keepsake Binder Insert.

### BRIEF SUMMARY OF THE INVENTION

The advantages of the specialty-designed binder insert, the Greeting Card Keepsake Binder Insert solves a previously existing problem of not being able to adequately maintain greeting card collections in a three-ring binder in an orderly, visible manner for the user to easily view, read, touch, and recall; which was not available before this invention.

### BRIEF DESCRIPTION OF THE DRAWINGS

The Greeting Card Keepsake Binder Insert was the conceptualization of a 3-hole binder insert with a specialty open slit that would adequately hold a greeting card to assist with current and future viewing.

### DETAILED DESCRIPTION OF THE INVENTION

The Greeting Card Keepsake Binder Insert was invented from a need to maintain and organize greeting card collections in a manner similar to loose-leaf paper collection in standard binders. The drawing provides an overview of a custom die to produce multiple greeting card keepsake binder inserts as the original filed specification for design application #29/698,716.

1. I claim:

1. the ornamental design for a greeting card keepsake binder insert as shown and described.
the utility feature of the Greeting Card Keepsake Binder Insert as necessary to maintain a collection of greeting cards in a three-ring binder.
